(19) United States
(12) Patent Application Publication
(10) Pub. No.: US 2017/0054553 A1
(43) Pub. Date: Feb. 23, 2017

(54) USING WEB ENTROPY TO SCRAMBLE MESSAGES

(71) Applicant: TELEFONAKTIEBOLAGET LM ERICSSON (PUBL), Stockholm (SE)

(72) Inventors: Makan POURZANDI, Montreal (CA); Mats NÄSLUND, Bromma (SE)

(21) Appl. No.: 15/307,163

(22) PCT Filed: Apr. 28, 2014
(86) PCT No.: PCT/IB2014/061066

§ 371 Date: Oct. 27, 2016

(51) Int. Cl. H04L 9/06; H04L 9/08

(52) U.S. Cl. CPC H04L 9/0662; H04L 9/0869

(57) ABSTRACT

According to one embodiment, an apparatus for scrambling a message is provided. The apparatus includes a processor and a memory in communication with the processor. The memory contains instructions executable by the processor that are configured to cause the apparatus to retrieve webpage data of at least one webpage. The at least one webpage is different from the message. The memory contains instructions executable by the processor that are configured to cause the apparatus to perform a hash operation on the webpage data to generate hashed webpage data, generate at least one pseudo-random value based at least in part on the hashed webpage data and generate a scrambled message by performing a first logical operation on the at least one generated pseudo-random value and the message.

### FIELD

The present invention relates to electronic message security and in particular to using one or more webpages as the basis for performing electronic message scrambling and descrambling.

### BACKGROUND

The increased availability of electronic devices and access to the internet has spurred growth in the use of the internet. In turn, the use of electronic forms of communication have continued to expand in popularity. For example, the use of email communications via personal computers, laptops and mobile devices has become common place throughout the world in both workplace and personal environments.

However, the increased use of the internet to exchange messages has also lead to the increase in massive surveillance efforts by various entities, i.e., mass eavesdroppers (ME). Massive surveillance generally refers to surveillance of at least a portion of a population by one or more MEs typically at the request of a ruling party, agencies and the like, or on the MEs' own accord. Many of these MEs use network gateways to detect and store bypassing messages from any individual. Some examples include authoritarian governments using gateways to log exchanged emails in order to scan communications, looking for various forms of “suspect” activity. Thus, anyone is a potential target in mass eavesdropping efforts, not only predetermined individuals already known to these eavesdropping entities.

In order for individuals to counteract these massive eavesdropping efforts, message exchange between peers can be protected using encryption. Encryption can be very secure but if the messages are intercepted by an eavesdropper and the eavesdropper can retrieve the keys, all exchanged messages can be decrypted by the eavesdropper. Another form of encryption called deniable encryption uses various keys. The sender encrypts a sensitive message using the first key. Later, if the user is asked about the sensitive message, the user is able to disclose the second key which has the property that decryption provides an “innocent” message and not the sensitive message.

The problems with these existing encryption approaches is that when the messages are encrypted using symmetric or asymmetric keys, the eavesdropper can decrypt the message as soon as the keys are made available to the eavesdropper. Further, the use of an encrypted message may itself trigger “interest” by monitoring entities, thereby causing problems for individuals. Further, while deniable encryption improves the situation since the sender can reveal a “faked” or “innocent” message, these systems require trusted third parties which may be hard to find.

### SUMMARY

The present invention advantageously provides an apparatus and method for scrambling and unscrambling data such as a message using one or more webpages.

According to one embodiment of the invention, an apparatus for scrambling a message is provided. The apparatus includes a processor and a memory in communication with the processor. The memory contains instructions executable by the processor that are configured to cause the apparatus to retrieve webpage data of at least one webpage, the at least one webpage being different from the message and perform a hash operation on the webpage data to generate hashed webpage data. The apparatus is further configured to generate at least one pseudo-random value based at least in part on the hashed webpage data and generate a scrambled message by performing a first logical operation on the generated at least one pseudo-random value and the message.

According to one embodiment of this aspect, the webpage data includes at least one of text of the webpage and HyperText Markup Language, HTML, code of the webpage. The webpage data not including advertisement data associated with the at least one webpage. According to another embodiment of this aspect, the message is recoverable from the scrambled message only if the same webpage data is retrieved from the at least one webpage. According to another embodiment of this aspect, the at least one webpage is a plurality of webpages. The hashed webpage data is generated for each corresponding webpage. The memory further contains instructions executable by the processor that are configured to perform a second logical operation on the hashed webpage data of the plurality of webpages. The generation of that at least one pseudo-random value is based at least in part on an output of the second logical operation.

According to another embodiment of this aspect, the second logical operation is an XOR operation. The hashed webpage data is XORed with one another. According to another embodiment of this aspect, the second logical operation is a hash function that is performed using the hashed webpage data as an input. According to another embodiment of this aspect, the first logical operation is an encryption function using the generated pseudo-random value as basis for a key. According to another embodiment of this aspect, the memory further contains instructions executable by the processor that are configured to apply a steganography scheme to the scrambled message.

According to another embodiment of the invention, a method for scrambling a message is provided. Webpage data of at least one webpage is retrieved. A hash operation is performed on the webpage data to generate hashed webpage data. At least one pseudo-random value is generated based at least in part on the hashed webpage data. A scrambled message is generated by performing a first logical operation on the at least one pseudo-random value and the message.

According to one embodiment of this aspect, the webpage data includes at least one of text of the webpage and HyperText Markup Language, HTML, code of the webpage. The webpage does not include advertisement data associated with the at least one webpage. According to another embodiment of this aspect, the message is recoverable from the scrambled message only if the same webpage data is retrieved from the at least one webpage. According to another embodiment of this aspect, the at least one webpage is a plurality of webpages. The hashed webpage data is generated for each corresponding webpage. A second logical operation is performed on the hashed webpage data of the plurality of webpages. The generation of the at least one pseudo-random value is based on an output of the second logical operation. According to another embodiment of this aspect, the second logical operation is an XOR operation. The hashed webpage data is XORed with one another. According to another embodiment of this aspect, the first logical operation is an encryption function using the generated pseudo-random value as basis for a key.

According to another embodiment of this aspect, a steganography scheme is applied to the scrambled message. According to another embodiment of this aspect, the first logical operation is an encryption function using the generated pseudo-random value as basis for a key.

According to another embodiment of the invention, an apparatus for unscrambling a scrambled message is provided. The scrambled message includes a message that was scrambled based at least in part on webpage data of at least one webpage retrieved. The apparatus includes a processor and a memory in communication with the processor. The memory contains instructions executable by the processor that are configured to cause the apparatus to receive the scrambled message, retrieve webpage data of the at least one webpage, perform a hash operation on the webpage data to generate hashed webpage data, generate at least one pseudo-random value based at least in part on the hashed webpage data, perform a first logical operation on the at least one pseudo-random value and the scrambled message, and recover the message from the scrambled message only if the retrieved webpage data of the at least one webpage is the same as the webpage data used to scramble the message.

According to one embodiment of this aspect, the webpage data includes at least one of text of the webpage and HyperText Markup Language, HTML, code of the webpage. The webpage data does not include advertisement data associated with the at least one webpage. According to another embodiment of this aspect, the at least one webpage is a plurality of webpages. The hashed webpage data is generated for each corresponding webpage. the memory further contains instructions executable by the processor that are configured to perform a second logical operation on the hashed webpage data of the plurality of webpages. The generation of the at least one pseudo-random value is based at least in part on the output of the second logical operation. According to another embodiment of this aspect, the second logical operation is an XOR operation. The hashed webpage data is XORed with one another. According to another embodiment of this aspect, the first logical operation is a decryption function using the generated pseudo-random value as basis for a key. According to another embodiment of this aspect, the memory further contains instructions executable by the processor that are configured to apply a steganography scheme to the scrambled message.

According to another embodiment of the invention, an apparatus for scrambling a message is provided. The apparatus includes a scrambling module configured to retrieve webpage data of at least one webpage, perform a hash operation on the webpage data to generate hashed webpage data, generate at least one pseudo-random value based at least in part on the hashed webpage data, and generate a scrambled message by performing a first logical operation on the at least one pseudo-random value and the message.

According to one embodiment of this aspect, the scrambling module is further configured to apply a steganography scheme to the scrambled message. According to another embodiment of this aspect, the webpage data includes at least one of text of the webpage and HyperText Markup Language, HTML, code of the webpage. The webpage data does not include advertisement data associated with the at least one webpage. According to another embodiment of this aspect, the message is recoverable from the scrambled message only if the same webpage data is retrieved from the at least one webpage. According to another embodiment of this aspect, the first logical operation is an encryption function using the generated pseudo-random value as basis for a key.

According to another embodiment of this aspect, the at least one webpage is a plurality of webpages. The hashed webpage data is generated for each corresponding webpage. The memory further contains instructions executable by the processor that are configured to perform a second logical operation on the hashed webpage data of the plurality of webpages. The generation of the at least one pseudo-random value is based at least in part on an output of the second logical operation. According to another embodiment of this aspect, the second logical operation is an XOR operation. The hashed webpage data is XORed with one another. According to another embodiment of this aspect, the first logical operation is an encryption function using the generated pseudo-random value as basis for a key.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary system for scrambling and unscrambling data in accordance with the principles of the invention;

FIG. 2 is a flow chart of an electronic message scrambling process for scrambling data in accordance with the principles of the present invention;

FIG. 3 is a detailed flow chart of the electronic message scrambling process in accordance with the principles of the present invention;

FIG. 4 is a flow chart of an electronic message unscrambling process for extracting scrambled data in accordance with the principles of the present invention;

FIG. 5 is a detailed flow chart of the electronic message unscrambling process in accordance with the principles of the present invention; and

FIG. 6 is a flow chart of an exemplary implementation of the electronic message scrambling of FIG. 2 in accordance with the principles of the present invention.

### DETAILED DESCRIPTION

The present invention advantageously provides an apparatus and method for scrambling a message using one or more webpages. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

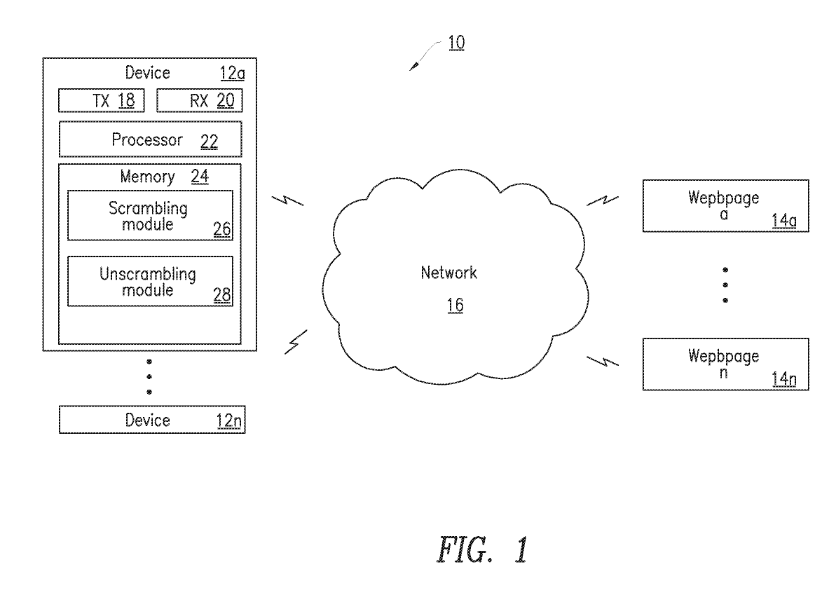

Referring now to drawing figures in which like reference designators refer to like elements there is shown in FIG. 1 an exemplary system for scrambling and unscrambling a message in accordance with the principles of the present invention and designated generally as “10.” As used herein, “scrambling” includes one or more forms of encryption based on one or more hashed-webpage as described herein. In other words, hashed web pages are used to generate the “scrambling key”. The forms of encryption may include Advanced Encryption Standard Cipher Block Chaining (AES_CBC) encryption, among other encryption operations. The term “message” as used herein may include electronic message(s) and email data but is not limited solely to emails and electronic messages such as text or SMS messages. A “message” may include data that represents information communicated from one party to another. System 10 may include one or more devices 12a-12n (device 12) and one or more webpages 14a-14n (webpage 14) in communication with each other via one or more networks 16.

Each webpage 14 may include respective webpage data, i.e., content, retrieved from one or more servers for display in a web browser that is different from the data or message to be scrambled. Some examples of webpage data include content corresponding to www.CNN.com or a blog from website www.wordpress.com, among a myriad of other content accessible via the world wide web. At least some webpage data associated with at least one webpage 14 may be controllable by user of device 12 such as a blogging site where the user of device 12 can modify at least some webpage data to change webpage 14 content, i.e., user of device 12 can post/remove/modify displayed text, media content and HTML text, among other content associated with webpage 14. In other words, at least some webpage data associated with at least one webpage 14 may be controlled by the sender and/or receiver of the scrambled message. Alternatively or in addition to at least some webpage data being controlled by sender (user of device 12) or receiver of the scrambled message, at least some webpage data of the at least one webpage 14 may not be controlled, i.e., modifiable, by the sender or receiver of the scrambled message. For example, at least some content associated with www.CNN.com may not be modifiable by the user of device 12 such as news story content and/or advertisement content that will change the webpage. In one embodiment, webpage data may include at least one of text of the webpage and HyperText Markup Language, HTML, code of the webpage in which the webpage data does not include advertisement data associated with the at least one webpage.

Network 16 may include communication networks such as wide area networks, local area networks, wireless local area network, long term evolution (LTE) network and the like, among other wired and/or wireless networks. Network 16 provides communications to and from device 12, and provides communications to and from webpage 14, i.e., server(s) hosting webpage 14. Network 16 may be the internet. Device 12 may include one or more transmitters 18 and one or more receivers 20 for communicating with network 16 and one or more webpages 14 associated with one or more website servers. Alternatively, transmitter 18 and receiver 20 functionality may be provided by one or more transceivers. Processor 22 includes one or more central processing units (CPUs) for performing device functions described herein. Device 12 may include memory 24 that stores scrambling module 26 and unscrambling module 28, among other data and modules. Memory 24 may include non-volatile and volatile memory. For example, non-volatile memory may include a hard drive, flash memory, memory stick and the like. Also, volatile memory may include random access memory and others known in the art.

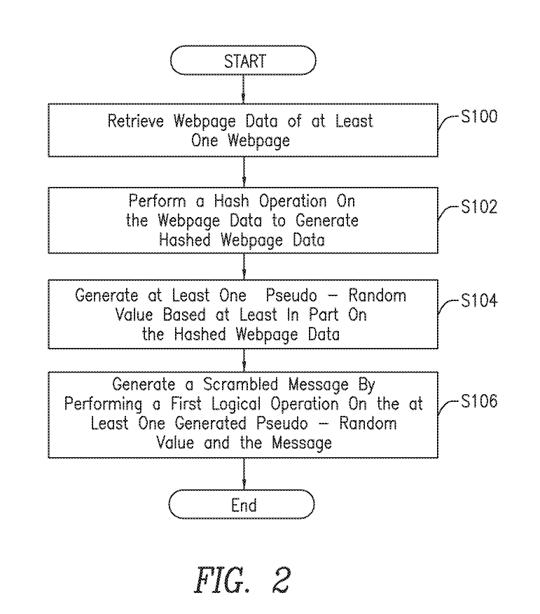

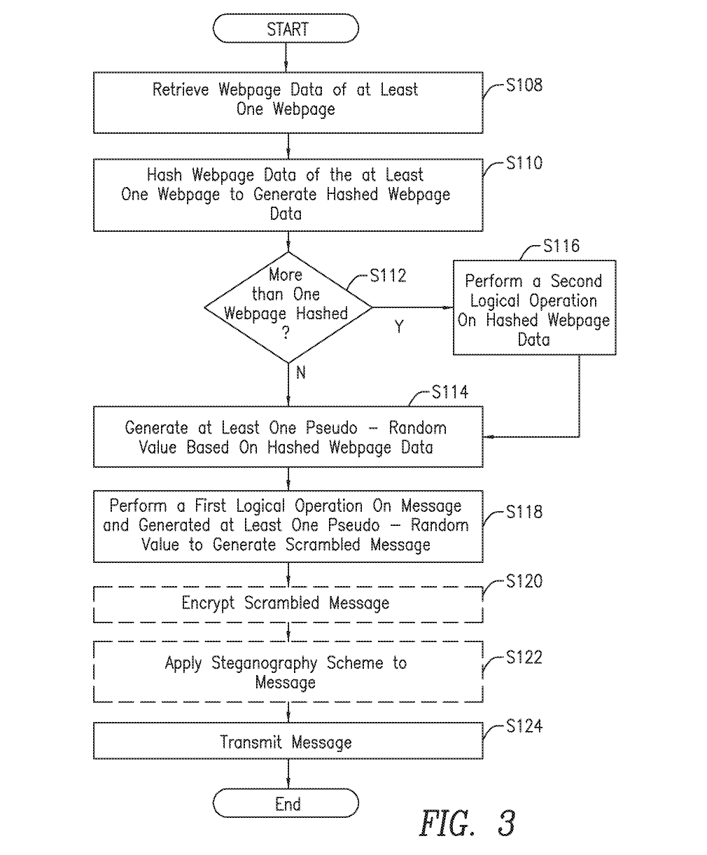

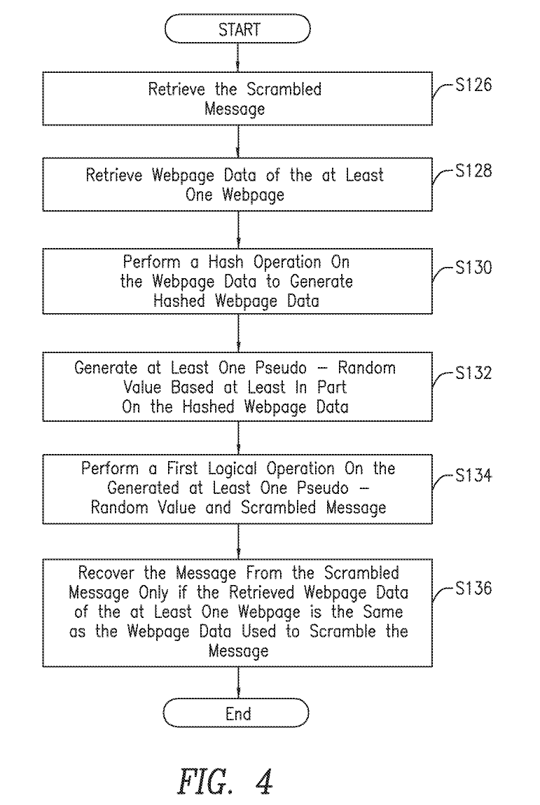

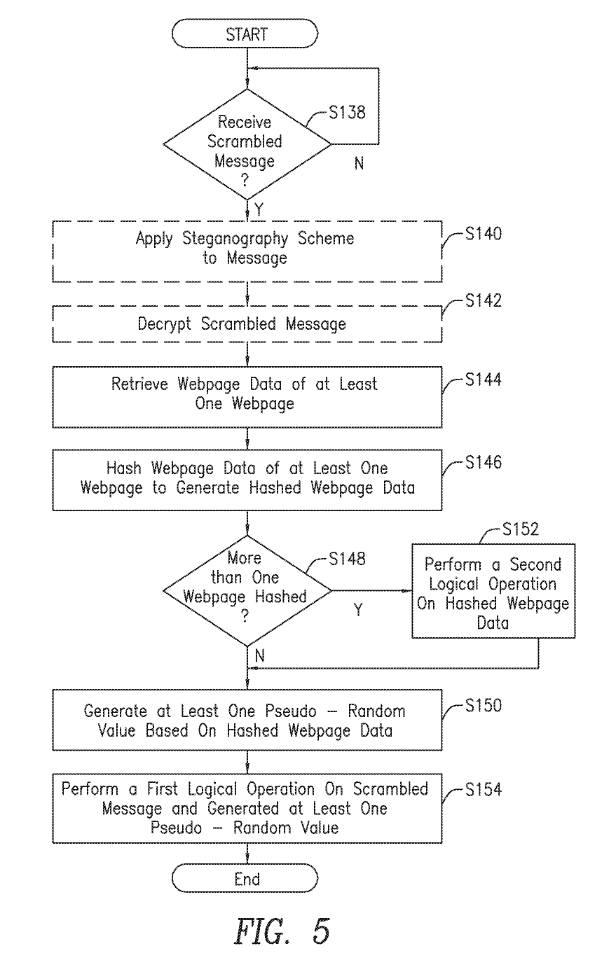

Memory 24 may store program instructions such as those for scrambling module 26 for providing one or more forms of encryption to a message. For example, scrambling module 26 includes instructions, which when executed by processor 22, cause processor 22 to perform the message scrambling process, discussed in detail with reference to FIGS. 2 and 3. Memory 24 may store program instructions for unscrambling module 28 for extracting the scrambled message. For example, unscrambling module 28 includes instructions, which when executed by processor 22, causes processor 22 to perform the unscrambling process, discussed in detail with reference to FIGS. 4 and 5. While device 12 is illustrated having multiple modules, device 12 may include one of modules 26 and 28. For example, one of devices 12 may only send a scrambled message such that only scrambling module 26 is needed. In another example, one of device 12 may only receive the scrambled message such that only the unscrambling module 28 is needed. While modules 26 and 28 are described as being software stored in memory, modules 26 and/or 28 may be hardware based or software-hardware based. Further, the separate programs can be a single program. Device 12 may be a mobile device, tablet, laptop, computer, server and the like, among other devices capable of performing the device 12 functionality described herein.

An exemplary process of scrambling module 26 for scrambling an electronic message is described with reference to FIG. 2. For example, user A of device 12a may want to send user B of device 12b a message (m) such as “This is my very secret message” in which the message is not contained in the one or more selected webpages discussed below. Processor 22, based on executable instructions stored in memory 24, causes webpage data associated with at least one webpage to be retrieved (Block S100). For example, processor 22 may retrieve webpage data from one or more user selected webpages 14. The selected webpages 14 may be in the user's control, e.g., user's blog, not in the user's control, e.g., cnn.com, or may be a mix of user controlled and/or non-user controlled webpages.

Alternatively or in addition to user selection of webpages 14, webpage data from one or more webpages 14 may be automatically selected by device 12. For example, device 22 may store in memory 24 one or more predefined uniform resource locators (URLs) from which to retrieve webpage data. The predefined URLs may be set by a person or entity other than the user of device 12 such as the software provider. In another example, the selection of the one or more webpages 14 from which to retrieve webpage data may be based at least in part on the respective entropy of the one or more webpages. In particular, the entropy of a webpage 14 is a measure of change, i.e., change rate or update rate, that at least a portion of the webpage undergoes over a predefined period of time such that the greater the entropy, the greater the change rate of at least a portion of the retrieved webpage data. For example, the entropy of the CNN webpage and/or a retailer's webpage may be higher than a weekly blogger's webpage as CNN may get updated at least once a day while the blogger's webpage gets updated once a week. Further, the entropy of a webpage is also affected by the extent to which the webpage has been updated. For example, an update for the CNN webpage may modify more webpage data than an update for the blogger's webpage. The entropy of one or more webpages may be determined by device 12 and/or one or more other devices and/or servers, e.g., as number of modified bits per unit of time or in another metric.

The retrieved webpage data may include media content and/or HTML code associated with the selected webpage 14. In one embodiment, processor 22 may remove or ignore retrieved webpage data corresponding to webpage advertisements and/or embedded graphics. In another embodiment, processor 22 may only use core text from the retrieved webpage data such as text associated with a main headline or story on the webpage. It is assumed that the sender and receiver have agreed on some method for selecting which part(s) of webpages 14 to use, or can agree on this over some form of communication channel. After webpage data has been retrieved, processor 22 performs a hashing operation on retrieved webpage data of the at least selected webpage to generate hashed webpage data (Block S102). For example, a respective hashing operation may be performed on retrieved webpage data of CNN.com and USPTO.gov such as to generate hashed webpage data H(CNN.com) and hashed webpage data H(USPTO.gov) where H is a hash function such as SHA-256, among other hash functions known in the art. For clarity, the input to the computation of the hash H (CNN.com) is not the string “CNN.com” but rather the content or webpage data of the associated webpage (or parts thereof) that are being used to scramble (encrypt) a message. One or more hash functions may be used in accordance with the principles of the invention.

Processor 22 generates at least one pseudo-random value based on the hashed webpage data (Block S104). The at least one pseudo-random value may include one or more numbers. For example, the hashed webpage data of one or more webpages 14 may be used as the Seed (S) for the pseudo-random number generator P to generate a “rough” where rough=P(S). The rough or output of the pseudo-random number generator may have the same number of bits as message m, i.e., the content or data to be scrambled. The pseudo-random number generator, P, may be based on Advanced Encryption Standard (AES) or other pseudo-random number generators that are well known in the art. Therefore, the entropy of the rough will be based on whether (all) the selected webpage(s) are known to the prospect eavesdropper and, if they are known, how often the selected webpage(s) change over time. If more than one webpage is hashed, one or more logical operations may be performed on the hashed webpage data in which the output of the one or more logical operation is used as the Seed (S) for the pseudo-random number generator P, as discussed in detail with respect to FIG. 3.

After pseudo-random numbers have been generated based on the hashed webpage data, processor 22 performs a logical operation on the content, e.g., message m, to be scrambled and generated pseudo-random numbers to generate a scrambled message (Block S106). In one embodiment, the logical operation may be an XOR function such that scrambled content or message m′=rough XOR m, where m is the original content and rough=P(Seed), discussed above. One or more other logical operations may be used in Block S106 in accordance with the teachings of the invention. As an example where multiple logical operations are used, processor 22 could produce m′=AES_CBC (Seed, m) or m′=AES_CBC (P(Seed), m), i.e., AES Cipher Block Chaining encryption of message m using Seed as basis for a key.

A detailed scrambling process of FIG. 2 for scrambling a message is described in detail with reference to FIG. 3. For example, user A of device 12a may want to send user B of device 12b a message (m) such as “This is my very secret message” in which the message is not contained in the one or more selected webpages discussed below. Processor 22 causes webpage data associated with at least one webpage to be retrieved, as described above with respect S100 (Block S108). After webpage data has been retrieved, processor 22 performs a hashing operation on retrieved webpage data of the at least selected webpage to generate hashed webpage data, as discussed in detail with respect to S102 (Block S110).

Processor 22 determines if more than one webpage was hashed (Block S112). If the determination is made that only one webpage was hashed in Block S110, processor 22 generates pseudo-random numbers based on the hashed webpage data, as discussed above with respect to S106 (Block S114). Referring back to Block S104, if processor 22 determines more than one webpage has been hashed, processor 22 performs a logical operation on the hashed webpage data (Block S116). In one embodiment, the logical operation may be an XOR function such that the output of the logical operation is H(webpage 14a) XOR H(webpage 14b) XOR . . . XOR H(webpage 14n) where webpages 14a-14n are selected webpages, i.e., the hashed webpage data is XORed with one another. The output of the logical operation becomes the Seed (S) for Block S114, i.e., rough=P(Seed), where Seed=H(webpage 14a) XOR H(webpage 14b) XOR . . . XOR H(webpage 14n). The number of hashed webpages may equal the number of selected webpages. One or more other logical operations may be used in Block S116.

After pseudo-random numbers have been generated based on the hashed webpage data, processor 22 performs a logical operation on the content to be scrambled, e.g., message m, and generated pseudo-random numbers to generate a scrambled message, as discussed in detail with respect to S106 (Block S118). The generation of pseudo-random numbers may be based at least in part on an output of the logical operation. In one embodiment, the logical operation may be an XOR function such that scrambled content or message m′=rough XOR m, where m is the original content and rough =P(Seed), discussed above. One or more other logical operations may be used in Block S118 in accordance with the teachings of the invention, e.g., m′=AES_CBC(Seed, m) or some other encryption function including one or more operations on Seed and m may be used as discussed above. If the sender and receiver of the scrambled message share another encryption key, k, processor 22 may perform additional encryption to the scrambled message by performing an encryption process with key k (Block S120). Alternatively, Block S120 may be skipped or omitted from the scrambling process based on design need.

Processor 22 may apply a steganography scheme to the scrambled message (Block S122). For example, processor 22 may apply a steganography crypto function such as text steganography. Stenography refers to hiding or concealing a message within an image or another message. In one embodiment, the steganography scheme may include embedding the scrambled message (m′) into a digital image file. Other steganography methods may be used in accordance with the principles of the present invention. Processor 22 causes the message (with or without the additional encryption of Block S120) to be transmitted (Block S124). Alternatively or in addition to transmitting the scrambled message to the receiver, the scrambled message may be posted on a webpage. In one embodiment, the one or more URLs of the one or more selected webpages 14 may be transmitted with the scrambled message. Alternatively, device 12 may automatically post the URLs on a webpage known by the recipient of the scrambled message such that the recipient will be able to unscramble the received message as discussed with respect to FIGS. 4 and 5. Optionally, a checksum of the Seed may also be transmitted, e.g., C=H(Seed) which may be used by the receiver of the scrambled message, as discussed in detail below. The invention is not limited to scrambling of a message, and may scramble other data.

A process of unscrambling module 28 for unscrambling a scrambled message is described with reference to FIG. 4. Processor 22 determines a scrambled message has been received (Block S126). Processor 22 retrieves webpage data of at least one webpage, i.e., at least one selected webpage (Block S128). For example, processor 22 causes webpage data of the one or more selected webpages to be retrieved. Because webpage data from the same selected webpage(s) used in the scrambling process may change over time, processor 22 at receiving device 12 may be retrieving the same or different webpage data than was used during by the transmission device 12 during the scrabbling process. Similar to Block S100, processor 22 may remove or ignore some retrieved webpage data such as webpage advertisements and/or embedded graphics. In another embodiment, processor 22 may only use core text from the retrieved webpage data such as text associated with a main headline or story on the webpage. In other words, processor 22 may be configured to automatically remove or ignore one or more portions of retrieved webpage data such that the same portions of retrieved webpage data are used during the scrambling and descrambling processes, albeit, the webpage data of these portions may or may not have changed from the time it was first retrieved.

Processor 22 hashes webpage data of the at least one webpage to generate hashed webpage data similar to Block S102 (Block S130). For example, a respective hashing operation may be performed on retrieved webpage data of CNN.com and USPTO.gov such as to generate hashed webpage data H(CNN.com) and hashed webpage data H(USPTO.gov) where H is a hash function such as SHA-256, among other hash functions known in the art. The hashed retrieved webpage data at Block S130 may or may not be different from the hashed retrieved webpage data of Block S102 as Block S132 uses webpage data retrieved at a later time (time₂) than a first time (time₁) when webpage data at Block S102 was retrieved (time₂>time₁).

Processor 22 generates pseudo-random numbers based on the hashed webpage data, as discussed in Block S104 but using webpage data retrieved at a later time, time₂ (Block S132). After processor 22 generates pseudo-random numbers based on the hashed webpage data, processor 22 performs a logical operation on both the scrambled message and generated pseudo-random numbers (Block S134). In one embodiment, the logical operation may be an XOR function such that unscrambled content or message m=rough XOR m′, where m is the original content, rough =P(seed) and m′ is the scrambled message. One or more other logical operations may be performed in Block S134 in accordance with the teachings of the invention. As mentioned, as an alternative to the above single XOR-operation, an AES_CBC decryption using Seed as the key may be performed. However, the original message will only be recovered if the webpage data, retrieved at time₂ by receiving device 12, is the same as the webpage data that was used by transmission/sender device 12 to generate the scrambled message, i.e., the message is recoverable from the scrambled message only if the same webpage data is retrieved from the at least one webpage. If the sender of the scrambled message included the checksum, C=H(Seed), the receiver may compute its own value for the checksum based on the local value of Seed′ obtained, i.e., C′=H(Seed′), and may abort further processing if C is not equal to C′, since this indicates at least selected webpage has changed, making further message recovery unfeasible.

In other words, the scrambled message may be considered a self-destroying message in which the message (m) is destroyed after at least one of the selected webpages modified such that the rough, i.e., rough=P(Seed), used to create the message will also be destroyed or is unlikely recoverable. The scrambled messages are automatically destroyed or unrecoverable over time without added effort from the sender of the scrambled message as at least one webpage 14 is automatically modified/updated over time by a third party, thereby changing the rough. One of the selected webpages 14 may correspond to a webpage that is modifiable by the sender and/or receiver such that the sender and/or receiver can change the webpage data of the webpage, thereby destroying the message. If the sender always selects one webpage in the sender's control to be part of the rough, then the sender can destroy all messages that use this particular webpage as part of the rough by modifying the webpage. On the other hand, if the sender selects a webpage 14 in control of the receiver, the receiver may update the controlled webpage after successful descrambling, thereby rendering further recover by an ME infeasible. This may also serve as a message receipt acknowledgement for the sender. After performing one or more logical operations on the generated pseudo-random numbers and scrambled message (m′), processor 22 may recover the message (m) from the scrambled message only if the retrieved webpage data (at Block S128) of the at least one webpage 14 is the same as the webpage data (Block S100) used to scramble the message (Block S136).

A detailed process for unscrambling of FIG. 4 is discussed in detail with respect to FIG. 5. Processor 22 determines whether a scrambled message has been received (Block S138). If processor 22 determines a scrambled message has not been received, processor 22 may repeat or periodically repeat the determination of Block S138. If processor 22 determines a scrambled message has been received, processor 22 may apply a steganography scheme to the received message (Block S140). For example, processor 22 may apply the same type of steganography scheme that was used in Block S122 to extract the scrambled message. Processor 22 may decrypt the message to extract the scrambled message (Block S142). Alternatively, Blocks S140 and/or S142 may be skipped or omitted based on design need or if Blocks S120 and/or S122 were skipped or omitted during the scrambling process. Alternatively, Block S140 may be performed as part of the determination of Block S138 as it may be required to apply a steganography scheme to the received message in order to detect that the scrambled message has been received and/or is available for further processing.

Processor 22 retrieves webpage data of at least one webpage 14, i.e., at least one selected webpage 14 (Block S144). For example, processor 22 causes webpage data of the one or more selected webpages to be retrieved. Because webpage data from the same selected webpage(s) used in the scrambling process may change over time, processor 22 at receiving device 12 may be retrieving the same or different webpage data than was used during by the transmission device 12 during the scrabbling process. Similar to Block S100, processor 22 may remove or ignore some retrieved webpage data such as webpage advertisements and/or embedded graphics.

In another embodiment, processor 22 may only use core text from the retrieved webpage data such as text associated with a main headline or story on the webpage. In other words, processor 22 may be configured to automatically remove or ignore one or more portions of retrieved webpage data such that the same portions of retrieved webpage data are used during the scrambling and descrambling processes, albeit, the webpage data of these portions may or may not have changed.

Processor 22 hashes webpage data of the at least one webpage 14 to generate hashed webpage data similar to Block S102 (Block S146). For example, a respective hashing operation may be performed on retrieved webpage data of CNN.com and USPTO.gov such as to generate hashed webpage data H(CNN.com) and hashed webpage data H(USPTO.gov) where H is a hash function such as SHA-256, among other hash functions known in the art, and H(CNN.com) is the hashed content of CNN.com. The hashed retrieved webpage data at Block S146 may or may not be different from the hashed retrieved webpage data of Block S102 as Block S146 uses webpage data retrieved at a later time (time₂) than the time (time₁) when webpage data at Block S102 was retrieved (time₂>time₁).

Processor 22 determines whether more than one webpage 14 has been hashed as described with respect to Block S104 (Block S148). If the determination is made that only one webpage was hashed in Block S148, processor 22 generates pseudo-random numbers/values based on the hashed webpage data, i.e., based on the hashed webpage, as described with respect to Block S104 (Block S150). Referring back to Block S148, if processor 22 determines more than one webpage has been hashed, processor 22 performs a logical operation on the hashed webpage data, as discussed with respect to Block S108 (Block S152). The logical operation(s) of Block S152 may be the same as the logical operation(s) performed in Block S116.

After performing the logical operation on the hashed webpage data, processor 22 generates pseudo-random numbers based on the hashed webpage data, as discussed with respect to Block S106. In one embodiment, the logical operation may be an XOR function such that the output of the logical operation of Block S152 is H(webpage 14a) XOR H(webpage 14b) XOR . . . XOR H(webpage 14n). The output of the logical operation becomes the “seed” for Block S150, i.e., rough=P(seed), where seed=H(webpage 14a) XOR H(webpage 14b) XOR . . . XOR H(webpage 14n) where webpages 14a-14n were selected. The number of hashed webpages may equal the number of selected webpages 14. One or more other logical operations may be used.

After processor 22 generates pseudo-random numbers based on the hashed webpage data, processor 22 performs a logical operation on both the scrambled message and generated pseudo-random numbers (Block S154). In one embodiment, the logical operation may be an XOR function such that unscrambled content or message m=rough XOR m′, where m is the original content, rough=P(seed) and m′ is the scrambled message. One or more other logical operations may be performed in Block S154. However, the original message will only be recovered if the webpage data, retrieved at a second time (time₂) by receiving device 12, is the same the webpage data that was used by device 12 to generate the scrambled message. In other words, the scrambled message may be considered a self-destroying message in which the message is destroyed after at least one of the selected webpages modified such that the rough, i.e., rough=P(Seed), used to create the message will also be destroyed or unlikely recoverable. The scrambled messages are automatically destroyed or unrecoverable over time without added effort from the sender of the scrambled message because at least one webpage is automatically modified/updated over time by a third party, thereby changing the rough. One of the selected webpages 14 may correspond to a webpage 14 that is modifiable by the sender and/or receiver such that the sender and/or receiver can change the webpage data of the webpage 14, thereby destroying the message. If the sender always selects one webpage in the sender's control to be part of the rough, then the sender and/or receiver can destroy all messages that use this particular webpage as part of the rough by modifying the webpage.

The scrambling process described herein makes the process of unscrambling the message difficult for an eavesdropper. For example, only one webpage may be selected, e.g., CNN.com, for the scrambling process in Block S100 and/or S108. For an eavesdropper to try to retrieve the message, the eavesdropper needs to monitor CNN.com and store all changes the webpage over time in order to be able to generate the same rough that was used to scramble the message. While this may be feasible for an eavesdropper with large resources, if the sender selects multiple, e.g., 10, webpages, the eavesdropper will have a very difficult time tracking all changes to these webpages 14 over time in order to reproduce webpage data from 2 weeks or 4 weeks ago. In one example, the multiple webpages 14 may be from blogs in Wordpress.com, blogs around the worlds or newspapers webpages 14 in Indonesia, and Kenya, among other webpages 14, thereby making tracking of each of these sites over an extended period of time very difficult. Further, selecting a mix of webpages having varying respective entropies, e.g., high entropy, low entropy, etc., helps ensure that the eavesdropper would need to store many millions of webpages 14 scattered all over the web in short time intervals such that the eavesdropper could search back through the stored webpages once the selected webpages become known to the eavesdropper. The eavesdropper is unlikely to be able to continuously make snapshots of the entire WEB over time and keep the snapshots over time, as such a process is extremely resource intensive and costly. One would have to try to unscramble using each page instance if multiple pages are used such as to make the process to unscramble unwieldy for an eavesdropper. Even the intended recipient of the message may be precluded from descrambling the message if the intended recipient waits too long, i.e., the recipient must retrieve webpage data from one or more selected webpages before one of the webpages are changed.

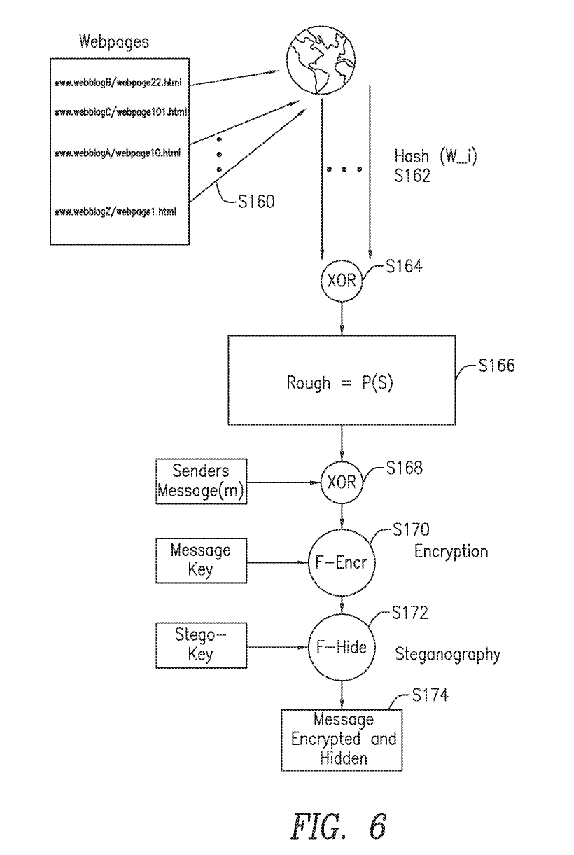

A flow diagram of an embodiment of the scrambling process of FIG. 2 is described with reference to FIG. 6. Webpage data of a plurality of selected webpages 14 is retrieved similar to Block S100 (S160). Each retrieved webpage 14 of the plurality of webpages 14 is hashed (H(W_i)) as described in Block S102 (S162). Processor 22 performs a logical operation, e.g., XOR operation, on the hashed webpage data of each of the plurality of webpages 14 such that the hashed webpage data is XORed with one another to generate a Seed (S) (S164). Processor 22 generates pseudo-random numbers/values, i.e., “rough”, based on hashed webpage data such that rough=P(S), where P is the pseudo-random number generator, as discussed above with respect to Block S104 (S166). Processor 22 performs a logical operation on the message m and rough. In one example, message m is XORed with the rough to generate a scrambled message, as discussed in detail with respect to Block S106 (S168). Processor 22 may further encrypt (F-Encr) the scrambled message, as discussed in detail with respect to Block S120 (Block S170). Processor 22 may apply a Stenography scheme to the scrambled message, as discussed in detail with respect to Block S122, thereby generating a scrambled message (S172-S174). The message key may be a stegno-key that is known to both the sender and receiver, k_msg, such that f-hide (rough, message, k_msg)=hidden_message, where f-hide is the steganography function based on the rough, message and k_msg. The hashed webpages may be the hash key. Key management is outside of the scope of this disclosure, and thus will not be discussed herein.

The invention advantageously provides a messaging system between peers with the capability of auto-destroying messages based on third party action even if an eavesdropper manages to acquire the message and keys used to encrypt the message. The invention takes advantage of one or more public webpages that are dynamic and change over time, e.g., www.CNN.com, such that instability is intentionally introduced to the message as the message will not be recoverable unless the same webpage data used to scramble the message is retrieved at a later time during the unscrambling process. In other words, the one or more selected webpages act as entropy sources. Further, the invention advantageously allows the sender to select at least one webpage in the sender's and/or receiver's control, e.g., a blogging webpage, such that the sender and/or receiver can destroy the message at any time by modifying the content of the blogging webpage. Assuming the sender and/or receiver delete the key, i.e., the rough, after it has been used in the descrambling process, then even if the sender and/or receiver are coerced into revealing the webpages for unscrambling the message, as the webpages change over time, the rough will change accordingly, thereby making it impossible even for the sender and/or receiver to reveal to key and thus invalidating/destroying the message. Therefore, an eavesdropper would have to not only know the keys for unscrambling the message but would have be able to retrieve the same webpage data to generate the same rough that was used to scramble the message, in which the webpage data is in the sender's and/or third parties' control from anywhere in the world.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings, which is limited only by the following claims.

1. An apparatus for scrambling a message, the apparatus comprising:
a processor; and
a memory in communication with the processor, the memory containing instructions executable by the processor that are configured to cause the apparatus to:
retrieve webpage data of at least one webpage, the at least one webpage being different from the message;
perform a hash operation on the webpage data to generate hashed webpage data;
generate at least one pseudo-random value based at least in part on the hashed webpage data; and
generate a scrambled message by performing a first logical operation on the at least one generated pseudo-random value and the message.

2. The apparatus of claim 1, wherein the webpage data includes at least one of text of the webpage and HyperText Markup Language, HTML, code of the webpage, the webpage data not including advertisement data associated with the at least one webpage.

3. The apparatus of claim 1, wherein the message is recoverable from the scrambled message only if the same webpage data is retrieved from the at least one webpage.

4. The apparatus of claim 1, wherein the at least one webpage is a plurality of webpages, the hashed webpage data being generated for each corresponding webpage; and
the memory further contains instructions executable by the processor that are configured to perform a second logical operation on the hashed webpage data of the plurality of webpages, the generation of that at least one pseudo-random value being based at least in part on an output of the second logical operation.

5. The apparatus of claim 4, wherein the second logical operation is an XOR operation, the hashed webpage data being XORed with one another.

6. The apparatus of claim 4, wherein the second logical operation is a hash function that is performed using the hashed webpage data as an input.

7. The apparatus of claim 1, wherein the first logical operation is an encryption function using the generated pseudo-random value as basis for a key.

8. The apparatus of claim 1, wherein the memory further contains instructions executable by the processor that are configured to apply a steganography scheme to the scrambled message.

9. A method for scrambling a message, the method comprising:
retrieving webpage data of at least one webpage;
performing a hash operation on the webpage data to generate hashed webpage data;
generating at least one pseudo-random value based at least in part on the hashed webpage data; and
generating a scrambled message by performing a first logical operation on the at least one pseudo-random value and the message.

10. The method of claim 9, wherein the webpage data includes at least one of text of the webpage and HyperText Markup Language, HTML, code of the webpage, the webpage not including advertisement data associated with the at least one webpage.

11. The method of claim 9, wherein the message is recoverable from the scrambled message only if the same webpage data is retrieved from the at least one webpage.

12. The method of claim 9, wherein the at least one webpage is a plurality of webpages, the hashed webpage data being generated for each corresponding webpage; and
the method further comprising performing a second logical operation on the hashed webpage data of the plurality of webpages, the generation of the at least one pseudo-random value being based on an output of the second logical operation.

13. The method of claim 12, wherein the second logical operation is an XOR operation, the hashed webpage data being XORed with one another.

14. The method of claim 9, wherein the first logical operation is an encryption function using the generated pseudo-random value as basis for a key.

15. The method of claim 9, further comprising applying a steganography scheme to the scrambled message.

16. The method of claim 9, wherein the first logical operation is an encryption function using the generated pseudo-random value as basis for a key.

17. An apparatus for unscrambling a scrambled message, the scrambled message including a message that was scrambled based at least in part on webpage data of at least one webpage retrieved, the apparatus comprising:
a processor; and
a memory in communication with the processor, the memory containing instructions executable by the processor that are configured to cause the apparatus to:
receive the scrambled message;
retrieve webpage data of the at least one webpage;
perform a hash operation on the webpage data to generate hashed webpage data;
generate at least one pseudo-random value based at least in part on the hashed webpage data;
perform a first logical operation on the at least one pseudo-random value and the scrambled message; and
recover the message from the scrambled message only if the retrieved webpage data of the at least one webpage is the same as the webpage data used to scramble the message.

18. The apparatus of claim 17, wherein the webpage data includes at least one of text of the webpage and HyperText Markup Language, HTML, code of the webpage, the webpage data not including advertisement data associated with the at least one webpage.

19. The apparatus of claim 17, wherein the at least one webpage is a plurality of webpages, the hashed webpage data being generated for each corresponding webpage; and
the memory further contains instructions executable by the processor that are configured to perform a second logical operation on the hashed webpage data of the plurality of webpages, the generation of the at least one pseudo-random value being based at least in part on the output of the second logical operation.

20. The apparatus of claim 19, wherein the second logical operation is an XOR operation, the hashed webpage data being XORed with one another.

21. The apparatus of claim 20, wherein the first logical operation is a decryption function using the generated pseudo-random value as basis for a key.

22. The apparatus of claim 17, wherein the memory further contains instructions executable by the processor that are configured to apply a steganography scheme to the scrambled message.

23. An apparatus for scrambling a message, the apparatus comprising a scrambling module configured to:
retrieve webpage data of at least one webpage;
perform a hash operation on the webpage data to generate hashed webpage data;
generate at least one pseudo-random value based at least in part on the hashed webpage data; and
generate a scrambled message by performing a first logical operation on the at least one pseudo-random value and the message.

24. The apparatus of claim 23, wherein the scrambling module is further configured to apply a steganography scheme to the scrambled message.

25. The apparatus of claim 23, wherein the webpage data includes at least one of text of the webpage and HyperText Markup Language, HTML, code of the webpage, the webpage data not including advertisement data associated with the at least one webpage.

26. The apparatus of claim 23, wherein the message is recoverable from the scrambled message only if the same webpage data is retrieved from the at least one webpage.

27. The apparatus of claim 23, wherein the first logical operation is an encryption function using the generated pseudo-random value as basis for a key.

28. The apparatus of claim 23, wherein the at least one webpage is a plurality of webpages, the hashed webpage data being generated for each corresponding webpage;
the memory further contains instructions executable by the processor that are configured to perform a second logical operation on the hashed webpage data of the plurality of webpages, the generation of the at least one pseudo-random value being based at least in part on an output of the second logical operation.

29. The apparatus claim 28, wherein the second logical operation is an XOR operation, the hashed webpage data being XORed with one another.

30. The apparatus of claim 29, wherein the first logical operation is an encryption function using the generated pseudo-random value as basis for a key.
